(19) United States
(12) Patent Application Publication
(10) Pub. No.: US 2025/0315976 A1
(43) Pub. Date: Oct. 9, 2025

(54) INDOOR POSITIONING SYSTEM BASED ON DATA-DRIVEN MODELING FOR ROBOTICS RESEARCH

(71) Applicant: UNIVERSITY OF SOUTH CAROLINA, COLUMBIA, SC (US)

(72) Inventors: YI WANG, CHAPIN, SC (US); JUNLIN OU, WEST COLUMBIA, SC (US)

(21) Appl. No.: 19/078,714

(22) Filed: Mar. 13, 2025

Related U.S. Application Data
(60) Provisional application No. 63/631,682, filed on Apr. 9, 2024.
(60) Provisional application No. 63/690,443, filed on Sep. 4, 2024.

(51) Int. Cl. G06T 7/73; G06T 7/246; G06T 7/292

(52) U.S. Cl. CPC G06T 7/74; G06T 7/248; G06T 7/292; G06T 2207/20081; G06T 2207/30204

(57) ABSTRACT

The disclosure deals with system and method subject matter for a low-cost, accurate indoor positioning system that integrates image acquisition and processing and data-driven modeling algorithms for robotics research and education. Multiple overhead cameras are used to obtain normalized image coordinates of ArUco markers, and presently disclosed methodology converts them to the camera coordinate frame. Various data-driven models are disclosed to establish a mapping relationship between the camera and the world coordinates. A number of data pairs (for example, 150) in the camera and world coordinates are generated by measuring the ArUco marker at different locations and then used to train and test the data-driven models. With the model, the world coordinate values of the ArUco marker and its robot carrier can be determined in real time. A straightforward polynomial regression approach can achieve a positioning accuracy of about 1.5 cm.

### PRIORITY CLAIM

The present application claims the benefit of priority of U.S. Provisional Patent Application No. 63/631,682, filed Apr. 9, 2024, titled Low-Cost Indoor Positioning System For Robotics Research And Education, and the benefit of priority of U.S. Provisional Patent Application No. 63/690,443, filed Sep. 4, 2024, titled Indoor Positioning System Based On Data-Driven Modeling For Robotics Research, and both of which are fully incorporated herein by reference for all purposes.

### BACKGROUND OF THE PRESENTLY DISCLOSED SUBJECT MATTER

The disclosure deals with system and method for low-cost, accurate indoor positioning that integrates image acquisition and processing and data-driven modeling algorithms for robotics research and education.

### 1. Introduction

Object positioning techniques [1, 2], particularly those low-cost but accurate, have gained significant traction in robotics research and education. Several of them have found widespread applications in the real world, such as location-based service and navigation. Global Positioning System (GPS) is one of the greatest revolutions in the localization application, and it can provide positioning information for almost all receivers on earth. However, it is not entirely amenable to indoor environments because the satellite signals can be blocked significantly by the walls of building construction [2]. Furthermore, the GPS accuracy (namely, the distance error between the ground truth and the reported position) of low-cost sensors is at the level of ˜meters, and therefore, it cannot satisfy the requirements of many indoor applications. Existing indoor positioning methods can be classified into three categories, including pedestrian dead reckoning (PDR) [3-5], communication technology [6-8], and computer vision [9-12], and each has its advantages and drawbacks.

PDR estimates the object's position through its past positions and the measurement data from magnetometers, gyroscopes, accelerometers, and others [12]. PDR is still a popular option for indoor localization and is often implemented through smartphones. However, its positioning error is generally high and accumulates as the object moves away from its initial location. Kuang et al. developed a PDR algorithm using a quasi-static attitude, a magnetic field vector, and a gravity vector. In addition, the motion constraint and gait models are applied to make PDR algorithm more robust. Experiments were performed to verify that the disclosed algorithm improved positioning accuracy over an existing PDR method. The mean positioning error could be up to 2.08 m.

Wang et al. proposed a motion-mode recognition-based PDR using smartphones. The decision-tree and support vector machine (SVM) algorithms were used to recognize phone poses and movement states, which improved localization accuracy. It was reported that the mean error of different phone poses was at least 1.38 m in a trajectory of 164 m. Liu et al. presented an enhanced PDR algorithm with the support of digital terrestrial multimedia broadcasting (DTMB) signals. Furthermore, the extended Kalman filter algorithm was used to fuse the information of the Doppler speed and range, and pedestrian walking speed and heading from DTMB signals and PDR, further boosting the performance. Compared with the native PDR, 95% of positioning errors of the enhanced PDR algorithm are much smaller and less than 3.94 m. However, the positioning accuracies of PDRs (including those with enhancement algorithms) generally are insufficient for the control or obstacle avoidance of mobile robots in the indoor environment.

Communication-based approaches include ultra-wideband (UWB), Bluetooth, Wi-Fi, radio frequency identification, and visible light communication. Compared to the PDR methods, they can provide more accurate positioning information, and their positioning errors do not change as the distance between the object and the initial location varies. Ruiz et al. compared the positioning performance of three commercial UWB positioning systems, BeSpoon, DecaWave, and Ubisense. It was found in experiments that DecaWave outperformed BeSpoon in accuracy and both exceeded the Ubisense. Within the same testing environment, the mean positioning errors of BeSpoon, DecaWave, and Ubisense were 0.71, 0.49, and 1.93 m, respectively. Sthapit et al. proposed a Bluetooth-based indoor positioning method using machine learning. Sample data from the Bluetooth device of low energy consumption were used to train a machine learning model. Then, experiments were carried out to evaluate the machine learning algorithm, and the average location error was found to be 50 cm. Increasing the sample size could further reduce the localization error. Han et al. presented a new WiFi-based approach (wireless networking technology which allows devices to connect to the internet via radio waves) along with an algorithm for indoor positioning. Their approach achieved a higher accuracy than the traditional WKNN (weighted K-nearest neighbor) algorithm. Specifically, the positioning errors of the proposed and the traditional WKNN algorithms are 0.25 and 0.37 m, respectively.

Computer vision-based methods for indoor positioning localize objects by analyzing contents in imagery or video data, and the widely used algorithms include clustering, matching, feature extraction, and deep learning. The accuracy of computer vision-based approaches usually is higher than that of their communication-based counterparts. However, the range of computer vision-based methods is limited since the view of a single camera is restricted, and this issue can be resolved by combining multiple cameras.

Jia et al. proposed a deep multipatch network-based image deblurring algorithm to enhance accuracy in indoor visual positioning by eliminating the blurry effect and improving the image quality, which achieved an average positioning accuracy of 8.65 cm in an office environment and outperformed other methods, such as continuous indoor visual localization and indoor image-based localization method. In ref. [20], an indoor visual positioning method utilizing image features was proposed. The image features were extracted from depth information and RGB channels in the images. Then, a bundle adjustment method and an efficient perspective n-point method were applied to implement indoor positioning. The disclosed method was verified in the real environment, and its root mean square error could reach 0.129 m. Li et al. presented an indoor visible light positioning system with optical camera communication. After capturing image data using the camera in a smartphone, a novel perspective-n-point problem algorithm was used to estimate the smartphone's position. The disclosed system was verified through experiments and obtained the mean position error of 4.81 cm while the object was placed at a height of 50 cm.

Lastly, high-quality computer vision-based localization systems are also commercially available, like OptiTrack camera systems and Vicon systems. They offer even higher positioning accuracy at the level of millimeters. However, such positioning systems typically use a large number of cameras from different perspective angles and need complicated installation, leading to high costs (ten thousand or several hundred thousand dollars depending on the quality). Hence, they are not affordable for robotics research and education in resource-limited environments or geographically underdeveloped regions. Therefore, there is a critical need for an indoor position system with an excellent balance between cost and accuracy because extremely high accuracy and precision may not be necessary for entry-or intermediate-level robotics research and education purposes.

The presently disclosed subject matter relates to how to retain desirable positioning accuracy (a few centimeters) and precision (˜1 cm) while keeping the equipment and the installation cost low (e.g., <$300). Such a system would not only generate positioning data to meet the need for research and educational programs but also represent a financially viable solution for advocating these activities.

### SUMMARY OF THE PRESENTLY DISCLOSED SUBJECT MATTER

The presently disclosed system and corresponding and/or associated methodology relates to low-cost, accurate indoor positioning integrates image acquisition and processing and data-driven modeling algorithms for robotics.

For some presently disclosed subject matter, multiple overhead cameras may be used to obtain normalized image coordinates of ArUco markers, which may then be converted per presently disclosed subject matter to the camera coordinate frame. A mapping relationship may then be established between the camera and the world coordinates.

The presently disclosed subject matter also has potential for use in robot control.

The disclosed system (both hardware and algorithms) can also contribute to robotic studies and education in resource-limited environments and underdeveloped regions.

For some present implementations, the presently disclosed subject matter for a low-cost, accurate indoor positioning system can have a total system cost of the range from $300-$500 (excluding the computer used). Data-driven models, such as polynomial regression, Kriging, and machine learning establish a mapping relationship between the camera and the world coordinates, where a number of data pairs in both the camera and world coordinates are generated by measuring the robot at different locations and then using such approach to train and test the data-driven models. With the presently disclosed subject matter, the world coordinate values of the robot (and its ID markers and payloads) can be determined in real time, with positioning accuracy of about ˜cm in real time.

Thought of another way, the presently disclosed subject matter presents a low-cost, accurate indoor positioning system for robotics research and education. In some configurations or embodiments, it integrates multiple cameras, an image acquisition, image processing and computer vision module, and data-driven models and can be used to localize mobile robots in robotic experiments and competition with cm-level positioning accuracy in real time. The presently disclosed subject matter primarily serves best entry-level robotics research and education, and also allows researchers and students to gain knowledge and skills in image processing, computer vision, and data-driven models. The general category of the presently disclosed subject matter relates at least in part to sensors, and various concepts relate also generally to indoor positioning systems, image processing, data-driven models, robotics, and autonomy.

Concerning the general areas of robotics research, education, and competition, mobile robots are used, and their locations need to be precisely determined for positioning, navigation, and control purposes. The presently disclosed subject matter relates to a low-cost indoor positioning system to accurately localize the robots in motion at real-time rate.

The anticipated market size for a low-cost indoor positioning system as presently disclosed is substantial. The niche market targeted by this presently disclosed subject matter is universities, K-12 schools, and other educational institutions, especially in resource-limited environments and underdeveloped regions. The presently disclosed subject matter offers researchers and students access to an affordable indoor positioning system for robotics research, education, and competitions. Additionally, it provides users with valuable hands-on experience in understanding indoor positioning principles and functions, computer vision, and data-driven models. Thus, the estimated number of potential users could easily reach at least 100,000. In recent years, there has been a rapid expansion in the size of the educational robot market, which is projected to increase from $1.71 billion in 2023 to $2.03 billion in 2024. In addition, the projected size of the global Robotics Market in 2024 is estimated to be USD 45.85 billion.

The presently disclosed indoor positioning system offers high positioning accuracy (˜cm) with much lower costs (50-100× cheaper) compared to existing commercial positioning systems, such as OptiTrack camera systems and Vicon systems. Although such commercial systems offer an even high accuracy ˜mm, such a high accuracy is not necessary for entry-level college research, and K-12 education and competitions.

To address accuracy and cost requirements referenced above, we disclose a cost-effective method and system for accurate indoor positioning for robotics research and education. The underlying idea is to utilize multiple low-cost cameras to acquire images on an ArUco marker attached to mobile robots. The cameras are arranged in a plane to significantly enlarge the view range for practical use and facilitate system installation. In addition, a new process that combines computer vision techniques to extract camera coordinates and data-driven models to establish a quantitative mapping between the camera and the world coordinates is also disclosed. The rationale for employing fiducial markers is that they have proven very effective in improving object positioning because of their highly distinguishable patterns [22]. ARTag, AprilTag, ArUco, and STag markers are the most widely used fiducial markers, and among them, the ArUco marker requires the lowest computation cost while maintaining salient positioning accuracy. Hence, it emerges as the best option for the presently disclosed system [23]. For example, the positioning accuracy of around 10 cm was achieved with the ArUco marker in experiments [2], although the positioning range is somewhat limited due to the use of only one camera.

Contributions of the presently disclosed subject matter may be in part summarized as follows:
1. A novel and holistic solution for low-cost (<$300) but accurate (error˜1.5 cm) indoor positioning for robotics research and education is disclosed. The system integrates hardware and algorithm development and software-hardware interfacing for automated image acquisition and processing, computing, and positioning, all in real time.
2. The present effort aims to push the limit of positioning accuracy by improving numerical algorithms and software while minimizing the overall cost of hardware and installation. Therefore, a new algorithmic pipeline is disclosed to combine computer vision and data-driven models, which converts the 2D images obtained by low-cost cameras to 3D world coordinates. Multiple algorithms and models are available for use in different scenarios.
3. All algorithms in Python and Matlab, including real-time image streaming from camera hardware, image processing and computer vision, and data-driven models, as well as experimental data for model training and testing presented in this present disclosure, are shared as an open source in the public domain (which open source library is available at https://github.com/iMSEL-USC/Indoor-Positioning-System-iMSEL).

It should be emphasized that the goal of the present effort is not to replace the high-quality indoor imaging systems of commercial grades for sophisticated robotics applications. Instead, it aims to realize a cost-effective system to meet basic research and education needs in resource-deficient environments.

The remainder of this disclosure is organized as follows. In Section 2, the indoor positioning system and multiple approaches for world coordinate estimation are described in detail. Section 3 introduces the experimental setup for data collection and evaluation of the positioning system. Experimental results and performance characterization are discussed in Section 4. Section 5 of the disclosure provides a brief summary and potential future efforts.

In various exemplary embodiments disclosed herewith, systems and/or methods are provided for indoor positioning systems for robotics research and education.

It is to be understood that the presently disclosed subject matter equally relates to associated and/or corresponding methodologies. One exemplary such method relates to a method for determining the position of a movable target in an established area, comprising tagging the movable target with a fiducial marker having a distinctive pattern; providing at least one camera positioned for outputting image coverage of the established area in which the target can move; producing camera coordinates of the fiducial marker; and inputting the camera coordinates of the fiducial marker into a trained model for estimating mapping of the world coordinates of the fiducial marker from the camera coordinates. Per such exemplary methodology, determining the world coordinates of the fiducial marker determines in the established area the position of the movable target tagged with the fiducial marker.

For some such method embodiments, producing camera coordinates of the fiducial marker can include producing normalized image coordinates of the fiducial marker from the collective image coverage; and producing camera coordinates of the fiducial marker.

Other example aspects of the present disclosure are directed to systems, apparatus, tangible, non-transitory computer-readable media, user interfaces, memory devices, and electronic devices for indoor positioning systems for robotics research and education. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a system for determining the position of a movable target in an established area, comprising a movable target tagged with a fiducial marker having a distinctive pattern; at least one camera positioned for outputting image coverage of the established area in which the target can move; and one or more processors programmed for producing camera coordinates of the fiducial marker; and inputting the camera coordinates of the fiducial marker into a trained model for estimating mapping of the world coordinates of the fiducial marker from the camera coordinates, whereby determining the world coordinates of the fiducial marker determines in the established area the position of the movable target tagged with the fiducial marker.

For some such system embodiments, producing camera coordinates of the fiducial marker can include producing normalized image coordinates of the fiducial marker from the collective image coverage; and producing camera coordinates of the fiducial marker.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the presently disclosed subject matter, including the best mode thereof to one of ordinary skill in the art, is set forth more particularly in the remainder of the specification, including reference to the accompanying figures in which:

FIG. 1 illustrates an exemplary flow chart diagram of presently disclosed method and workflow subject matter of the presently disclosed low-cost indoor positioning technology;

FIG. 2 diagrammatically illustrates the relationships between representative camera and world coordinate frames, respectively, both relative to an exemplary ArUco marker;

FIG. 3 diagrammatically illustrates the relationships between representative normalized image coordinates and the camera coordinates of the exemplary ArUco marker;

FIG. 4 diagrammatically illustrates an exemplary neural network model as can be used in conjunction with presently disclosed subject matter;

FIG. 5(a) illustrates an image of an exemplary camera installation on a custom mount in accordance with presently disclosed technology;

FIG. 5(b) illustrates images of an exemplary floorboard taken by three exemplary cameras in accordance with presently disclosed technology;

FIG. 6 illustrates a generally top and side view image of an exemplary 3D printed table in accordance with presently disclosed subject matter for holding an exemplary ArUco marker;

FIG. 7(a) illustrates a generally top and side view image of an exemplary lab jack to vary the heights of the ArUco marker, in accordance with presently disclosed subject matter;

FIG. 7(b) illustrates a generally top and side view image of an exemplary table (FIG. 6) on the exemplary lab jack (FIG. 7(a));

FIG. 8 diagrammatically illustrates a view of an exemplary floorboard and an indirect method for determining the location of an exemplary ArUco marker, in accordance with presently disclosed technology;

FIG. 9(a) illustrates a chart (Table 1) representing the distance from a given point A to a given point B as measured by three persons;

FIG. 9(b) illustrates a chart (Table 2) representing the distances from points A and B to different markers and corresponding x and y coordinates of such markers;

FIG. 9(c) illustrates a chart (Table 3) representing the height of various markers (in units of meters);

FIGS. 9(d) and 9(e) respectively illustrate 3D and 2D views for training points and testing points (different color points, for example, black and red points, are used for training and testing, respectively), in accordance with presently disclosed technology;

FIG. 9(f) illustrates a chart (Table 4) representing performance of nine different methods in 3D indoor positioning, comparing such models for all three cameras (as shown in FIGS. 5(a) and (b)) in mean accuracy, lower bound, upper bound, and standard deviation;

FIGS. 10(a), 10(b), and 10(c) respectively illustrate graphically the effect of the number of training data points on 3D positioning accuracy, from the (a) red, (b) white, and (c) black cameras, respectively;

FIG. 10(d) illustrates a chart (Table 5) representing performance of nine different methods in the 2D domain, comparing such models for all three cameras (as shown in FIGS. 5(a) and(b)) in mean accuracy, lower bound, upper bound, and standard deviation;

FIGS. 11(a), 11(b), and 11(c) respectively illustrate graphically the effect of the number of training data points on 2D positioning accuracy, from the (a) red, (b) white, and (c) black cameras, respectively; and

FIGS. 12(a) through 12(f) respectively illustrate images from an exemplary experiment to verify the feasibility of using the presently disclosed indoor positioning system for robot control and research uses.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to system and methodology subject matter which is for indoor positioning systems for robotics research and education.

### 2. Positioning Method and System

In this section, the positioning method and system is introduced, and the data-driven models used to calibrate and improve the world coordinate estimation are also described in detail. FIG. 1 illustrates an exemplary flow chart diagram of presently disclosed method and workflow subject matter of the presently disclosed low-cost indoor positioning technology. As shown in FIG. 1, the entire exemplary pipeline comprises two stages, offline training and online testing/utilization. During the offline training stage, multiple overhead cameras will be used to capture the image of the floorboard (labeled “a” in FIG. 1), and the ArUco marker will be placed at specified locations and heights.

Then, the image is processed to obtain the normalized image coordinates (u, v, 1) of the ArUco marker using OpenCV (labeled “b”). The normalized image coordinates are then converted to the camera coordinates (X_{c}, Y_{c}, Z_{c}) using a new algorithm disclosed in this present disclosure (labeled “c”). Meanwhile, through manual measurement (labeled “d”), the ground truth values of the world coordinates (X_{W}, Y_{W}, Z_{W}) of the ArUco marker are attained (labeled “e”). These steps, that is, image acquisition and processing and computing camera coordinates and true world coordinate values, are repeated multiple times by placing the ArUco marker at different locations, which will generate sufficient data pairs of the camera and world coordinates. A data-driven model (labeled “f”), such as rigid transformation, polynomial regression, artificial neural network, and Kriging will be trained to establish a mapping relationship F between the camera coordinate (as input) and world coordinates (as output) in the previous steps. During the online testing/utilization stage, the mobile robot carrying the ArUco marker will be captured by the overhead cameras, and the image will be processed to produce the normalized image coordinates (u, v, 1) and camera coordinates (X_{c}, Y_{c}, Z_{c}) following the same procedure above (i.e., “a”, “b”, and “c” steps). Differently, the camera coordinate will be entered as the input to the data-driven model F trained in the offline stage to immediately estimate the world coordinates (\hat{X}_{w}, Ŷ_{w}, \hat{Z}_{w}) (labeled “g”). In other words, the trained data-driven model is utilized (as shown by the blue arrow) in the online stage.

### 2.1. Camera Coordinate Frame

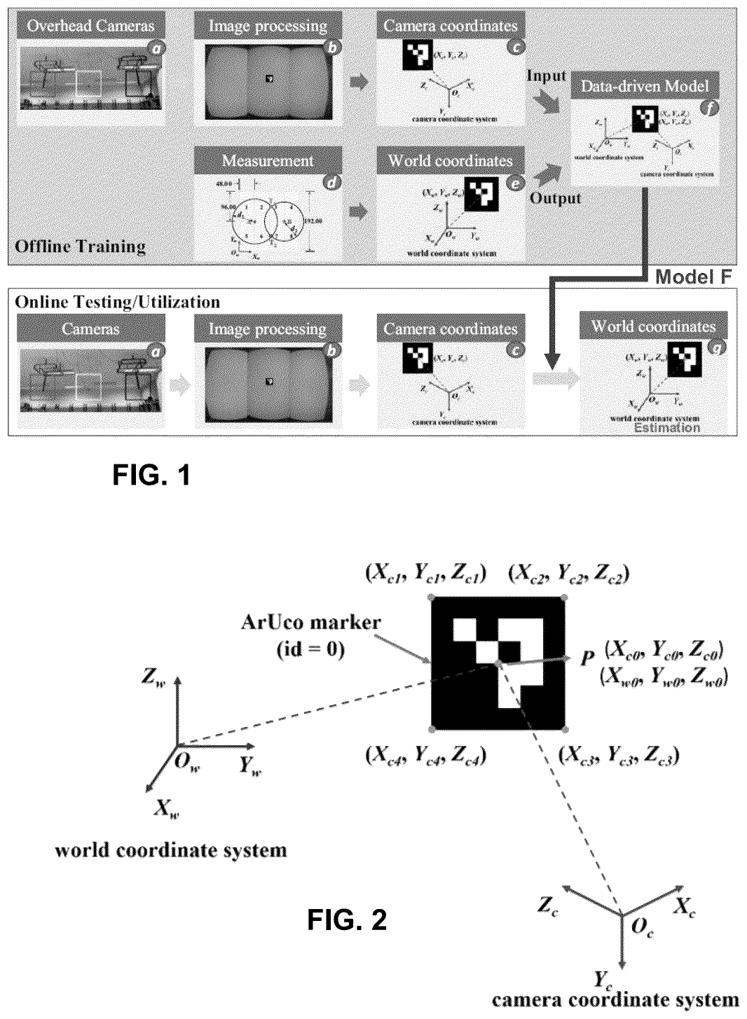

FIG. 2 diagrammatically illustrates the relationships between representative camera and world coordinate frames, respectively, both relative to an exemplary ArUco marker. As shown in FIG. 2, (X_{c}, Y_{c}, Z_{c}) and (X_{w}, Y_{w}, Z_{w} ) represent the camera and world coordinate frames, respectively. For a point located at the center of the ArUco marker, its camera and world coordinate values are (X_{c0}, Y_{c0}, Z_{c0}) and (X_{w0}, Y_{w0}, Z_{w0}), respectively. The marker has a square shape and four corner points, which are denoted by (X_{c1}, Y_{c1}, Z_{c1}), (X_{c2}, Y_{c2}, Z_{c2}), (X_{c3}, Y_{c3}, Z_{c3}), and (X_{c4}, Y_{c4}, Z_{c4}) in the camera coordinate frame. In conjunction with describing our lab experiments, a process (detailed in Section 3) is disclosed to align the cameras almost parallel to the floorboard. The ArUco marker is placed flat on the floorboard and has a small size; therefore, it is valid to assume Z_{c1}=Z_{c2}=Z_{c3}=Z_{c4}.

The length L of the four edges of the ArUco marker in the camera coordinate is the same and can be expressed as

$$\begin{matrix}L = \sqrt{{( {X}_{cj} - {X}_{ci} )}^{2} + {( {Y}_{cj} - {Y}_{ci} )}^{2} + {( {Z}_{cj} - {Z}_{ci} )}^{2}} \approx \\ \sqrt{{( {X}_{cj} - {X}_{ci} )}^{2} + {( {Y}_{cj} - {Y}_{ci} )}^{2}} \\ = \frac{1}{4} {\sum }_{i = 1}^{4} \sqrt{{( {X}_{cj} - {X}_{ci} )}^{2} + {( {Y}_{cj} - {Y}_{ci} )}^{2}}\end{matrix} \qquad ( 1 )$$

where i=1, 2, 3, and 4, j=mod (i, 4)+1, and ‘mod’ operation denotes the remainder after division.

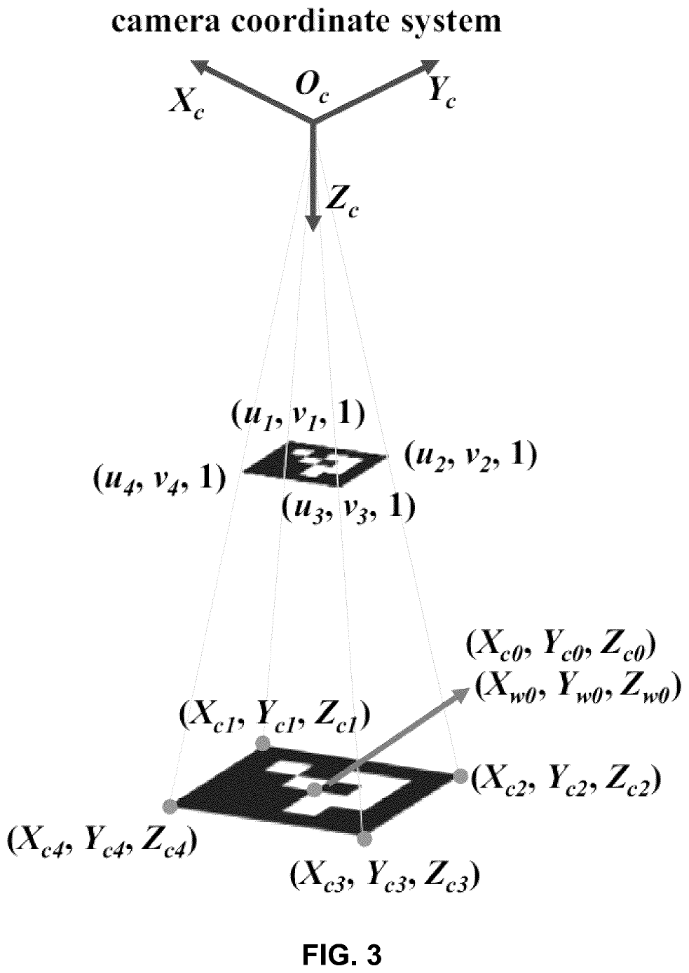

Usually, the values of the corners (X_{ci}, Y_{ci}, Z_{ci}) in the camera coordinate frame are unknown. However, we can find them from their normalized coordinates (u, v, 1) using OpenCV undistortPoints( ) function, where u=X_{c}/Z_{c} and v=Y_{c}/Z_{c}. This function corrects lens distortion and normalizes the coordinates of detected points. FIG. 3 diagrammatically illustrates the relationships between representative normalized image coordinates and the camera coordinates of the exemplary ArUco marker. According to the triangle similarity Theorems (FIG. 3), Eq. (2) can also be expressed as

$$L = \frac{{Z}_{c 0}}{4} {\sum }_{i = 1}^{4} \sqrt{{( {u}_{j} - {u}_{i} )}^{2} + {( {v}_{j} - {v}_{i} )}^{2}} \qquad ( 2 )$$

where Z_{c0} is the value of Z_{c} at the marker center, and Z_{c0}=Z_{c1}=Z_{c2}=Z_{c3}=Z_{c4} because the marker is small, flat, and almost parallel to the camera. In this present disclosure, the marker length L is measured manually, which allows us to calculate Z_{c0} of the marker by

$${Z}_{c 0} = \frac{4 L}{{\sum }_{i = 1}^{4} \sqrt{{( {u}_{j} - {u}_{i} )}^{2} + {( {v}_{j} - {v}_{i} )}^{2}}} \qquad ( 3 )$$

As the marker is a square, the x and y coordinates of its center, that is, X_{c0} and Y_{c0}, can be written as

$${X}_{c 0} = {\sum }_{i = 1}^{4} {X}_{ci} = \frac{{Z}_{c 0}}{4} {\sum }_{i = 1}^{4} {u}_{i} . \qquad ( 4 )$$

$${Y}_{c 0} = {\sum }_{i = 1}^{4} {Y}_{ci} = \frac{{Z}_{c 0}}{4} {\sum }_{i = 1}^{4} {v}_{i} . \qquad ( 5 )$$

Thus, the camera coordinate values of the marker's center, that is, (X_{c0}, Y_{c0}, Z_{c0}) can be completely determined by Eqs. (3)-(5).

### 2.2. World Coordinate Frame

The next step is to transform the ArUco marker from the camera coordinate frame to the world coordinate frame for localization in the real environment. To establish the transformation relationship F between them, that is, (X_{w}, Y_{w}, Z_{w})=F(X_{c}, Y_{c}, Z_{c}), the true value of the ArUco marker in the world coordinate frame is needed and can be manually measured by treating one location in the real environment as the origin. Note that the location of the ArUco marker in the camera coordinate is now known following the procedure in Section 2.1. The ArUco marker is placed at multiple locations, and the measurement is repeated accordingly, which yields a dataset containing many pairs of (X_{c}, Y_{c}, Z_{c}) and (X_{w}, Y_{w}, Z_{w}), each corresponding to one marker location. The dataset is then split into two groups, respectively, for training and testing of model F.

The transformation relationship F can be identified by various data training/learning approaches, such as rigid transformation, polynomial regression, Kriging interpolation, machine learning, and others, which are described in detail below.

### 2.2.1. Rigid Transformation

Rigid transformation is the most widely used approach to estimate mapping between the camera and the world coordinates. It is a kind of transformation that does not change the Euclidean distance of every pair of points, such as translations and rotations (that are considered in this present disclosure). It is mathematically expressed as

$$[ \begin{matrix}{X}_{w} \\ {Y}_{w} \\ {Z}_{w} \\ 1\end{matrix} ] = [ \begin{matrix}{R}_{3 \times 3} & {Γ}_{3 \times 1} \\ {0}_{1 \times 3} & 1\end{matrix} ] [ \begin{matrix}{X}_{c} \\ {Y}_{c} \\ {Z}_{c} \\ 1\end{matrix} ] \qquad ( 6 )$$

where R and r are the rotation matrix and translation matrix, respectively. Given the dataset in the camera and world coordinate frames above, R and r can be computed by singular value decomposition (SVD) [24, 25]. The data pairs in the camera frame X and in the world frame Y are

$$X = ( \begin{matrix}{x}^{( 1 )} \\ ⋮ \\ {x}^{( n )}\end{matrix} ) , Y = ( \begin{matrix}{y}^{( 1 )} \\ ⋮ \\ {y}^{( n )}\end{matrix} ) \qquad ( 7 )$$

where X∈ [symbol] is the matrix composed of n observations for the three measured input quantities (X_{c}, Y_{c}, and Z_{c}), that is, each entry x⁽ⁱ⁾=(X_{c}⁽ⁱ⁾, Y_{c}⁽ⁱ⁾, Z_{c}⁽ⁱ⁾) is the ith observation and 0≤i≤n; Y∈ [symbol] is the matrix containing n measurements for the three output quantities (X_{w}, Y_{w}, or Z_{w}), and each entry y⁽ⁱ⁾=(X_{w}⁽ⁱ⁾, Y_{w}⁽ⁱ⁾, Z_{w}⁽ⁱ⁾). The centroids of X and Y are calculated by

$$\overline{X} = \frac{1}{n} {\sum }_{i = 1}^{n} {x}^{( i )} , and \overline{Y} = \frac{1}{n} {\sum }_{i = 1}^{n} {y}^{( i )} \qquad ( 8 )$$

Note that X̅∈ [symbol] and Y̅∈ [symbol] are row vectors in 3D. Then, the covariance matrix H [24, 25] is defined as

$$H = {( X - \overline{X} )}^{T} ( Y - \overline{Y} ) \qquad ( 9 )$$

(X−X̅) is an operation that each row of X is subtracted by X̅. Then, H is decomposed by SVD to produce U and V:

$$[ U , S , V ] = SVD ( H ) \qquad ( 10 )$$

Thus, the R and r can be obtained

$$R = {VU}^{T} \qquad ( 11 )$$

$$Γ = {\overline{Y}}^{T} - R {\overline{X}}^{T} \qquad ( 12 )$$

However, even with camera calibration, the issue of image distortion is still present, leading to a poor estimation of the marker location in the camera coordinate frame. Therefore, rigid transformation solely may be insufficient to yield an accurate estimation of the world coordinate values in the testing stage. Thus, other data-driven modeling methods that can incorporate additional nonlinearity into the mapping relationship F are also examined in this present disclosure.

### 2.2.2. Polynomial Regression

Polynomial regression is a widely used approach to build the mapping relationship F between inputs and output responses, in which polynomial terms of inputs are used as regressors. In this present disclosure, X_{c}, Y_{c}, and Z_{c} are inputs, and X_{w}, Y_{w}, and Z_{w} are outputs, and F can be determined by

$$Y = ξ F + v \qquad ( 13 )$$

where ξ∈ [symbol] is a matrix composed of nₚ regressors at the n observations. In this present disclosure, our regressors include the constant, linear (i.e., X_{c}, Y_{c}, and Z_{c}), and the second-order nonlinear terms (X_{c}Y_{c}, X_{c}Z_{c}, Y_{c}Z_{c}, X_{c}², Y_{c}² and Z_{c}²) of the input variables, and hence nₚ=10. F∈ [symbol] is a matrix of model coefficients to be estimated, and v∈ [symbol] is the matrix of the measurement errors for all the three outputs. The ordinary least-squares solution [26] to F is the best linear unbiased estimator (BLUE) and can be obtained by minimizing a cost function summing over all the squared residuals at each data point, yielding

$$\hat{F} = {( {ξ}^{T} ξ )}^{- 1} {ξ}^{T} Y \qquad ( 14 )$$

Once \hat{F} is estimated in the offline training stage, it can be used for online real-time estimation of the marker center in the world coordinate frame, that is, X_{w0}, Y_{w0}, and Z_{w0}.

### 2.2.3. Artificial Neural Network Model

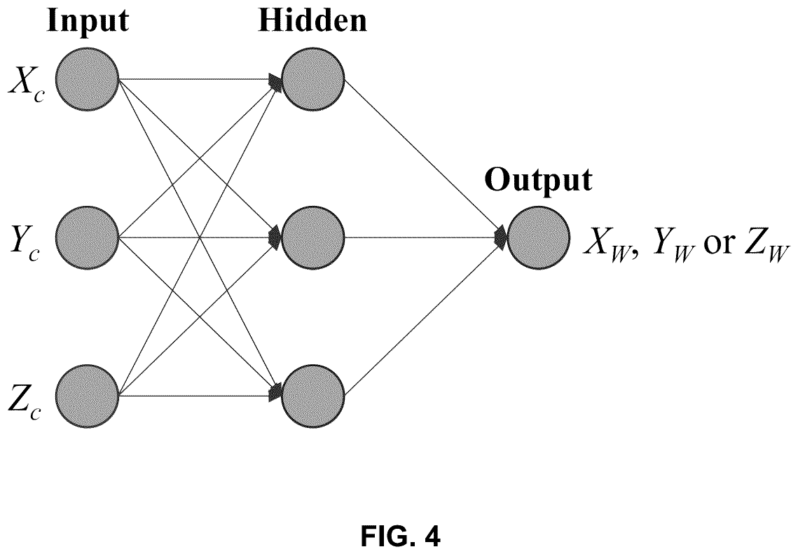

The data-driven model in regression analysis can also be obtained by the machine learning approach [27], and specifically, the artificial neural network model (ANN) is adopted in this present disclosure. ANN comprises many neurons arranged in layers operating in parallel and can be mathematically described by a nonlinear weighted sum. The weights defining the strength of the connection between the neurons are trained through backpropagation to approximate the underlying mapping between the inputs and outputs. In this present disclosure, the multilayer feed-forward neural network (MLFNN) architecture is employed to construct three ANN models, respectively, for X_{w}, Y_{w}, and Z_{w}, that is, each individual output will be modeled separately. FIG. 4 diagrammatically illustrates an exemplary neural network model as can be used in conjunction with presently disclosed subject matter. Thus, the model shown in FIG. 4 includes three inputs, three neurons in the hidden layer, and one output, and the number of neurons is determined through a trial-and-error process. In addition, the activation function of the hidden layer is the Tan-Sigmoid function. The activation function of the output layer is a linear function. Likewise, once the ANN model is trained, it can be used for online estimation of the marker center in the world coordinate frame.

### 2.2.4. Kriging Interpolation Model

Kriging, proposed by Krige and Sacks, is a data-driven interpolation technique to predict the response surface [28]. It was originally used in geostatistics and gradually applied to various engineering fields. In this present disclosure, the Kriging interpolation model is first developed to capture the mapping relationship F between the camera coordinate value, x=(X_{c}, Y_{c}, and Z_{c}) and the world coordinate value y=(Xw, Yw, or Zw) as presented above. The model has two components: a regression model f(x) to estimate the global trend of the data landscape and a Gaussian process model Z(x) with zero mean and variance σ² to capture the difference between the trend function and the true response surface. Therefore, the Kriging model reads

$$y ( x ) = F ( x ) = f ( x ) + Z ( x ) \qquad ( 15 )$$

The regression model f(x) can be a known or unknown constant or a multivariate polynomial, yielding various categories of the Kriging model. The correlation matrix Ψ for observation data for the Gaussian process model is defined as

$$Ψ = ( \begin{matrix}ψ ( {x}^{( 1 )} , {x}^{( 1 )} ) & … & ψ ( {x}^{( 1 )} , {x}^{( n )} ) \\ ⋮ & ⋱ & ⋮ \\ ψ ( {x}^{( n )} , {x}^{( 1 )} ) & … & ψ ( {x}^{( n )} , {x}^{( n )} )\end{matrix} ) \qquad ( 16 )$$

where Ψ is the correlation function for observation data, and the most widely used correlation functions include the Gaussian, exponential, spline, linear, and spherical functions. Furthermore, the hyperparameters (including σ² above) in the Kriging model are computed through the maximum likelihood estimation (MLE) [29]. The predicted mean of Kriging interpolation is given by

$$\hat{y} ( x ) = M α + r ( x ) {Ψ}^{- 1} ( Y - ξ α ) \qquad ( 17 )$$

$$where M = ( {b}_{1} ( x ) {b}_{2} ( x ) … {b}_{{n}_{p}} ( x ) ) \qquad ( 18 )$$

$$α = {( {ξ}^{T} {Ψ}^{- 1} ξ )}^{- 1} {ξ}^{T} {Ψ}^{- 1} Y \qquad ( 19 )$$

$$r ( x ) = [ ψ ( x , {x}^{( 1 )} ) … ψ ( x , {x}^{( n )} ) ] \qquad ( 20 )$$

and bⱼ is the jth polynomial regressor and aj is the corresponding coefficient, and 0≤j≤nₚ. ξ is the observation matrix as described above, and the estimated mean-squared error by the predictor is

$${s}^{2} ( x ) = {σ}^{2} ( 1 - r ( x ) {Ψ}^{- 1} {r ( x )}^{T} + \frac{1 - ξ {Ψ}^{- 1} {r ( x )}^{T}}{{ξ}^{T} {Ψ}^{- 1} ξ} ) \qquad ( 21 )$$

In this present disclosure, the DACE (design and analysis of computer experiments) toolbox in MATLAB [30] is adopted for constructing the kriging model, and the linear regression model and Gaussian correlation model are used. Three Kriging models are developed for each component in the world coordinate values (X_{w}, Y_{w}, Z_{w}).

### 2.2.5. Kriging Regression Model

The predictor in Eq. (21) is for Kriging interpolation, well-suited for modeling more deterministic data. In contrast, the Kriging model can also be modified for regression to model data with significant noises and uncertainties that are governed by another Gaussian process n (x) with the zero mean and covariance matrix Σ

$$η ∼ GP ( 0 , Σ ) \qquad ( 22 )$$

Following a similar procedure above, the corresponding Kriging regression predictor is [26]

$$\hat{y} ( x ) = M α + r ( x ) {( Ψ + \frac{1}{{σ}^{2}} Σ )}^{- 1} ( Y - ξ α ) \qquad ( 23 )$$

The type and distribution of noises produce different covariance matrices. The simplest form of the covariance matrix describing the noise and uncertainty is

$$Σ = ( \begin{matrix}var ( {y}^{( 1 )} ) & 0 & 0 \\ 0 & ⋱ & 0 \\ 0 & 0 & var ( {y}^{( n )} )\end{matrix} ) \qquad ( 24 )$$

where var(y⁽ⁱ⁾) is the variance of the ith data observation. Furthermore, the noise can be assumed homogeneously distributed across all the input observations, and therefore, the covariance matrix can be set as Σ=10^{∈}Iₙ, where ∈ is used to quantify the amount of noise and can be determined as a hyperparameter using the MLE above. In this present disclosure, the ooDACE Toolbox is utilized to construct the model [31]. Likewise, three kriging regression models are constructed for predicting the world coordinate X_{w}, Y_{w}, and Z_{w}, respectively.

### 2.2.6. Hybrid Models

In this present disclosure, hybrid models that combine rigid transformation and data-driven models are also disclosed to enhance positioning accuracy. Specifically, rigid transformation is first used to obtain intermediate values (\tilde{X}_{w}, \tilde{Y}_{w}, \tilde{Z}_{w}), which are then entered as the input to one of the data-driven models above, that is, polynomial regression, ANN, Kriging interpolation, and Kriging regression to further improve the world coordinate estimation (X_{w}, Y_{w}, Y_{w}.).

### 3. System Hardware and Experimental Setup

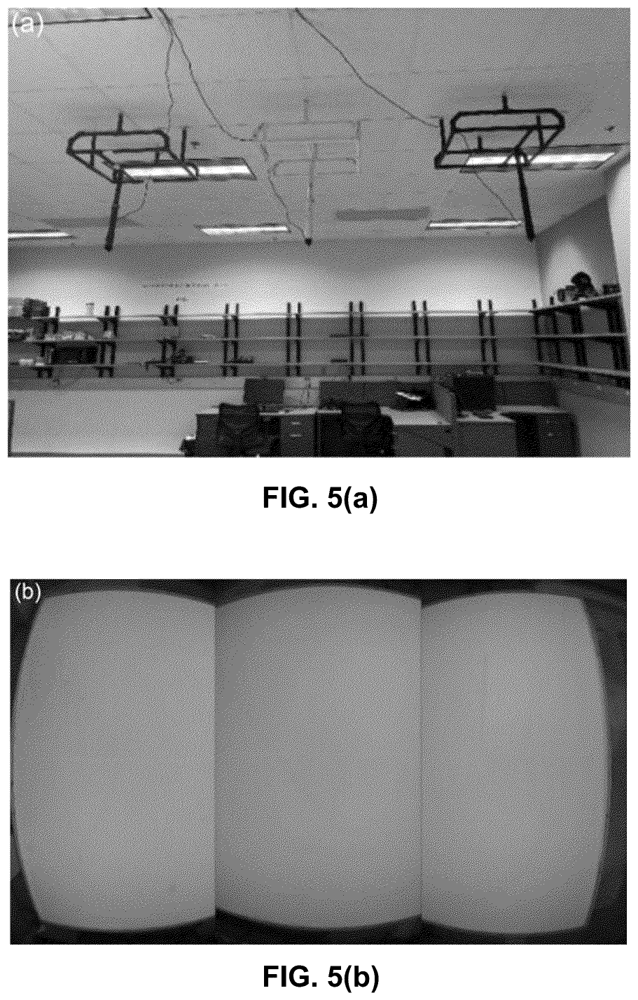

As discussed above, the goal of this disclosure is to provide a cost-effective indoor positioning system for robotics research and education. FIG. 5(a) illustrates an image of an exemplary camera installation on a custom mount in accordance with presently disclosed technology. In particular, FIG. 5(a) illustrates the three low-cost cameras installed on a custom mount attached to the ceiling for detecting and localizing the marker. The cameras may be for example ELP 180-degree Fisheye cameras with a unit price of around $50. Their resolution is set as 1920×1080. A low-end PC is also needed for image data acquisition and processing. FIG. 5(b) illustrates images of an exemplary floorboard taken by three exemplary cameras in accordance with presently disclosed technology. Thus, FIG. 5(b) presents the images of different areas of a white floorboard taken by these cameras, and the border regions between two adjacent cameras have partial overlap. To ensure the entire ArUco marker is within at least one camera view at any time, the overlap area needs to be larger than the ArUco marker. In other words, at any location of the floorboard, the camera coordinates (X_{c}, Y_{c}, Z_{c}) of the ArUco marker can be obtained using the image processing procedure in Eqs. (3), (4), and (5). The custom mounts are made of PVC pipes, on which the cameras can be moved along three perpendicular dimensions to adjust their orientations relative to the floorboard. However, it should be noted that the custom mount of the 3-axis motion used in our robotics research is not mandatory for the disclosed indoor positioning system. In addition, the three mounts are painted in three different colors, red, white, and black, which also refer to the attached cameras hereafter.

During installation, all these cameras need to be aligned almost parallel to the floorboard. Therefore, a few markers (four used in this present disclosure) are placed at different locations to estimate the largest difference between their Z_{c} values within the view of a camera. Then the camera is adjusted manually to make the difference as small as possible. The adjustment process is repeated for all three cameras. However, eliminating the difference is almost impossible because of the image distortion, particularly with the low cost cameras, and is also unnecessary as our data-driven models will correct and improve the estimation regardless. Therefore, when their difference is less than 5 cm, the camera is considered parallel with the floorboard.

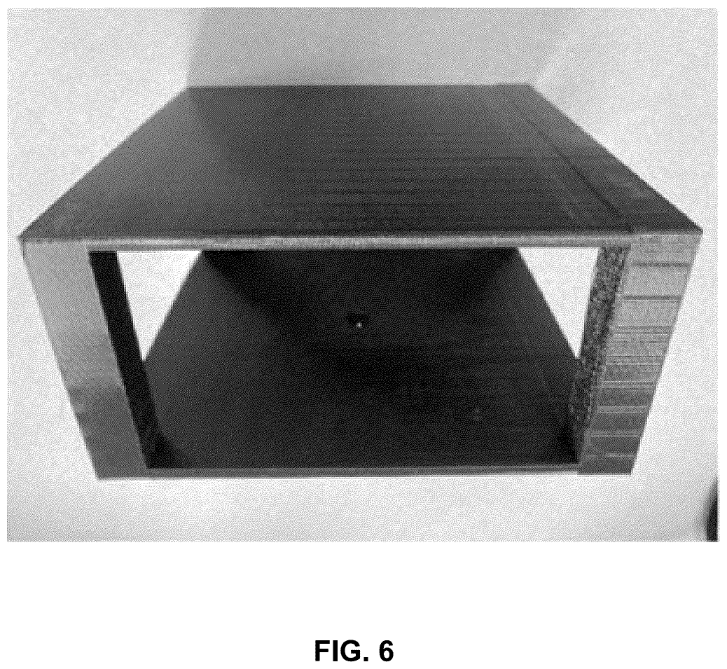

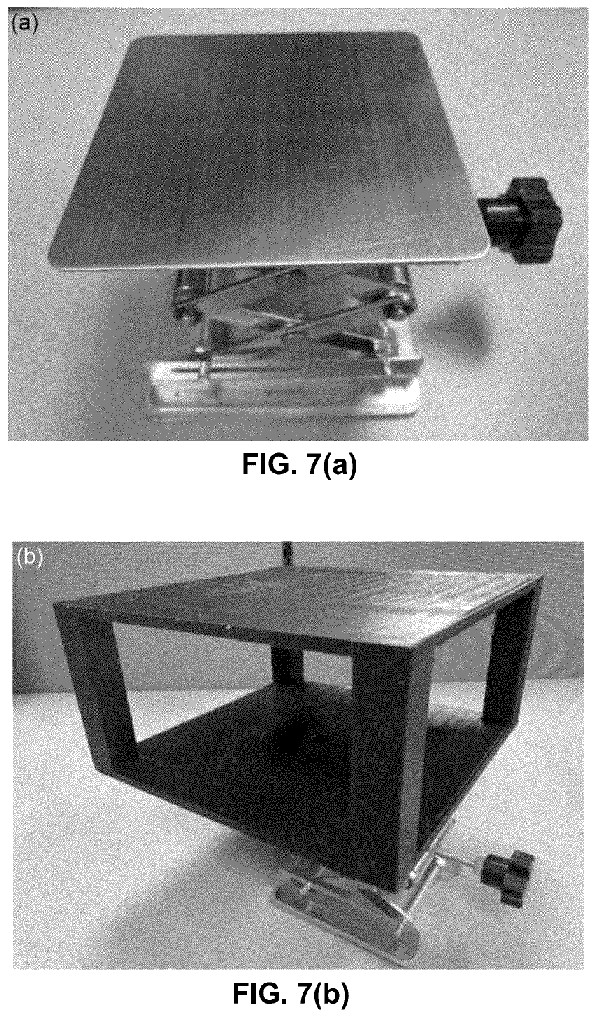

FIG. 6 illustrates a generally top and side view image of an exemplary 3D printed table in accordance with presently disclosed subject matter for holding an exemplary ArUco marker. To place the ArUco marker at different heights, that is, Zw, relative to the floorboard, the small table which is represented in FIG. 6 is devised and 3D printed, and has an exemplary size of 20 cm (length)×20 cm (width)×5 cm (height). The marker used in this present disclosure is 20 cm (length)×20 cm (width), and thus, it can be placed exactly on the top surface of the table. There is a small hole at the center of the bottom layer of the table, which is also the projected location of the marker's center when it is placed on the table. To continuously vary the marker's heights, a lab jack (a Scissor Stand Platform of 4″×4″) may be used to lift the table up and down. FIG. 7(a) illustrates a generally top and side view image of an exemplary lab jack to vary the heights of the ArUco marker, in accordance with presently disclosed subject matter. FIG. 7(b) illustrates a generally top and side view image of an exemplary table (FIG. 6) on the exemplary lab jack (FIG. 7(a)). The height of the lab jack can be changed from 4.5 to 15 cm, and the exact height of the marker above the floorboard is measured by a ruler, which corresponds to the Z_{w}, coordinate value in the world frame.

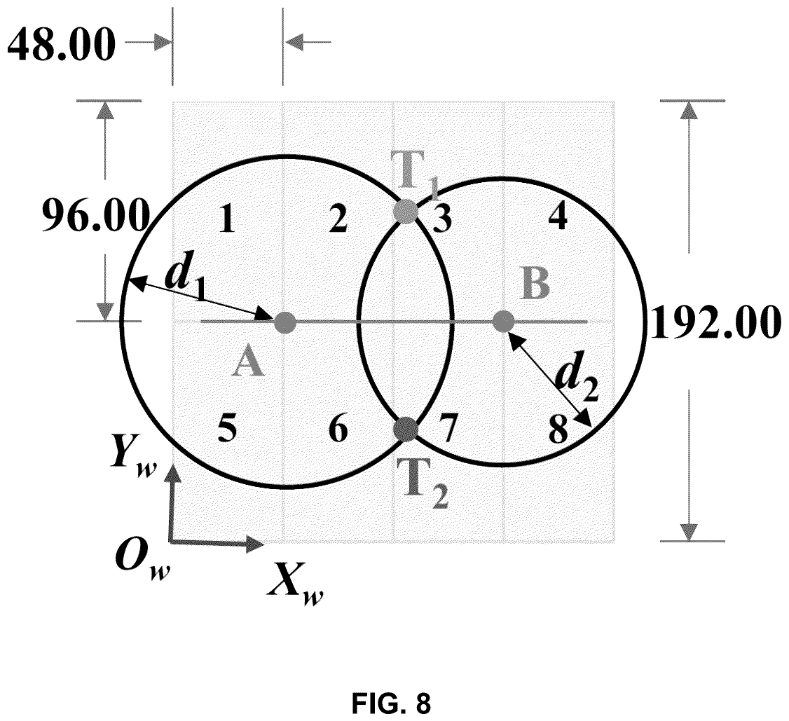

FIG. 8 diagrammatically illustrates a view of an exemplary floorboard and an indirect method for determining the location of an exemplary ArUco marker, in accordance with presently disclosed technology. The floorboard in this exemplary experiment is made of 8 wooden boards (48 inches×96 inches each) and can be entirely covered by the combined views of the three cameras (FIG. 5(b)). Thus, its total area is 192 inches×192 inches (about 4.88 m×4.88 m), as shown in FIG. 8. In this present disclosure, the coordinates of any location on the floorboard are measured indirectly using referenced points rather than directly from the origin. It is difficult to measure X_{w} and Y_{w} coordinate values directly from the origin because it requires X_{w} and Y_{w} axes to be set exactly perpendicular to each other. Further, when measuring the distance from a location to X_{w} and Y_{w} axes, the ruler also needs to be perpendicular to both axes. Both of these are not easy to achieve manually. Thus, a different approach that makes use of two referenced points is disclosed to determine the X_{w} and Y_{w} coordinates of the ArUco marker under the camera's view. The two reference points used in this present disclosure include point A (1.2192, 2.4384, 0) and point B (3.6576, 2.4384, 0) with a unit of meter. There are two reasons for choosing these two reference points. First, they are the intersection points of the wooden boards and can be easily found. There are kind of in the middle of the view area, and all locations on the floorboard are not far away from them.

Specifically, we measure the distances, d₁ and d₂ from the marker location to Point A and Point B, which are given by

$$\{ \begin{matrix}{( {X}_{w , g} - {X}_{w , A} )}^{2} + {( {Y}_{w , g} - {Y}_{w , A} )}^{2} = {d}_{1}^{2} \\ {( {X}_{w , g} - {X}_{w , B} )}^{2} + {( {Y}_{w , g} - {Y}_{w , B} )}^{2} = {d}_{2}^{2}\end{matrix} \qquad ( 25 )$$

where X_{w,g} and Y_{w,g} denote the world coordinates of the marker and will be determined by solving Eq. (25). The Z_{w,g} coordinate value of the marker is known since the height of the table on which the marker is placed can also be measured. Once obtained, (X_{w,g}, Y_{w,g}, Z_{w,g}) will be used as the true value of the world coordinate for model training. However, as shown in FIG. 8, the marker can be located at T₁ or T₂, and both of their distances to Point A and Point B satisfy Eq. (25). Thus, when we measure the distances, the position of the marker relative to the red line AB is also recorded. If the marker's location is above the red line AB, then X_{w,g} and Y_{w,g} coordinate values corresponding to T₁ are accepted. Otherwise, those of T₂ will be taken.

The following describes an exemplary, non-limiting process of estimating hand-measurement errors. Although the reference point approach is delicately designed in this given example to allow easier and more reliable measurement and reduce associated errors, it is significant to collect additional data and explicitly estimate the accuracy and the uncertainty of the hand-measured training data used for model development. As shown in FIG. 8, two reference points, point A (1.2192, 2.4384, 0) and point B (3.6576, 2.4384, 0), with a unit of meter, are used. The coordinate of point A is regarded as the ground truth and the anchor point for all the subsequent measurements. However, it should be emphasized that the accuracy of the absolute coordinate of point A is not important because our positioning approach is based on the relative distances of the estimated location to Point A and Point B. The y-coordinate of Point B is also treated as the ground truth, which is a reasonable assumption since point B and point A together determine a line, and the line in this present disclosure is the edge of the floorboard. Subsequently, a tape is used to measure the distance of 2.4384 m along the line from point A to determine the x-coordinate of point B.

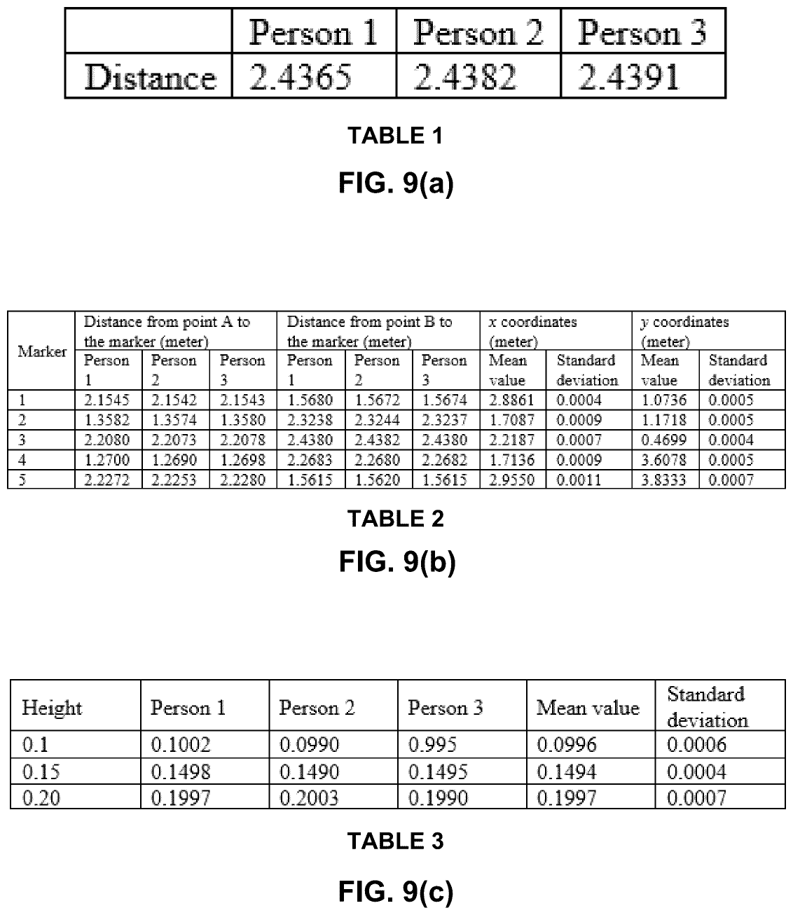

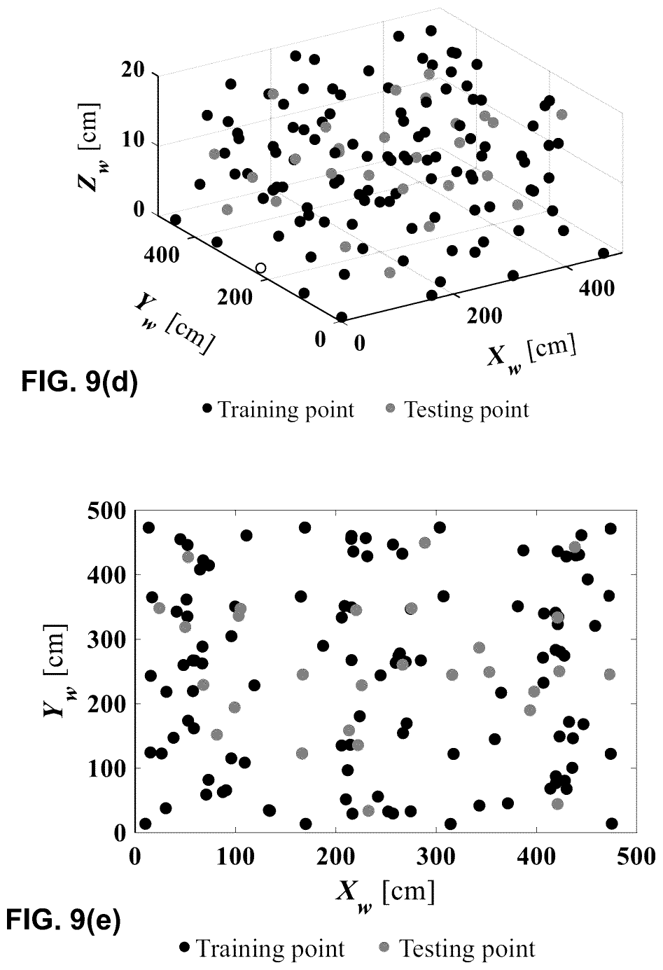

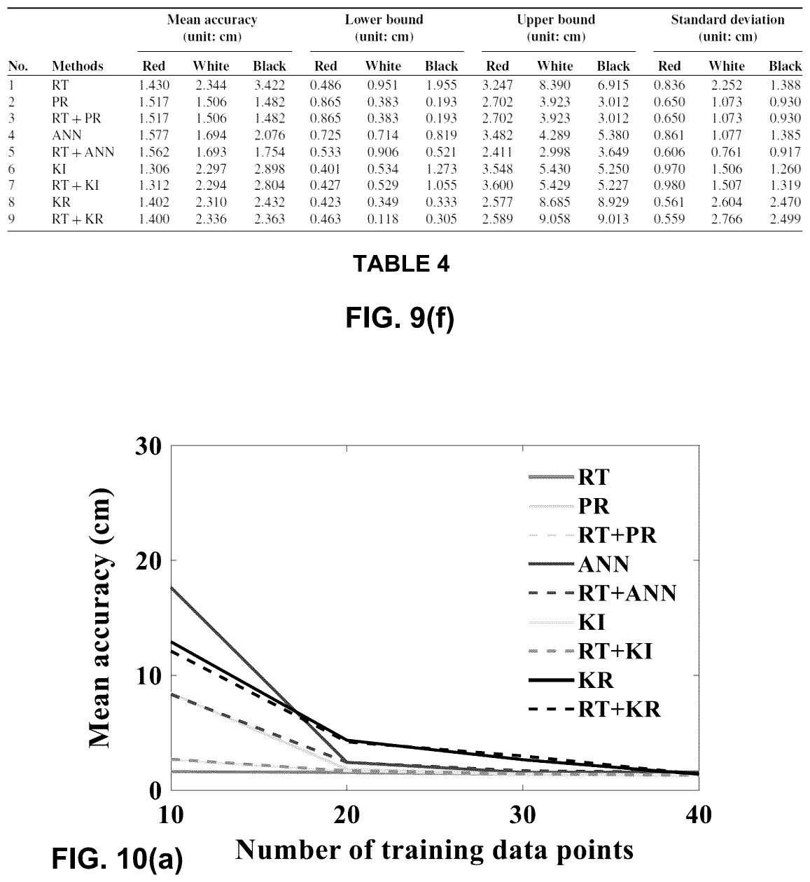

Note that the hand measurement of this distance can introduce an error and is important. To quantify this error, three individuals are asked to independently measure the distance from point A to point B, as shown in FIG. 9(a) (which is shown in a chart labeled Table 1). Thus, the actual x coordinate of point B is from 2.4365 to 2.4391 m, which is very close to 2.4384 m above. To quantify the hand-measurement errors of ArUco markers, three individuals are asked again to measure the distance from 5 marker locations to points A and B, as shown in FIG. 8, which are summarized in FIG. 9(b) (which is presented in a chart labeled Table 2). Based on the distance from point A to point B (3 measurements) and the distance from the markers to points A (3 measurements) and B (3 measurements), we could obtain 27 combinations of these measurements, assuming they are completely independent of each other. Accordingly, this yields 27 values of x and y coordinates for each marker location using the equations in this present disclosure.

The mean values and standard deviation for the x and y coordinates are shown in FIG. 9(b) (Table 2), and the largest standard deviation is 0.0011 m which shows that the hand-measurement errors are satisfactory. Furthermore, the error of the z-coordinate is also very small as we directly place the marker either on the floorboard (z=0 m) or on a table that is 3D-printed with a predetermined height (5 cm) or on the table that is fixed on a lab jack. The lab jack is used to increase the height of the marker to 10, 15, and 20 cm. As shown in FIG. 9(c) (presented as Table 3), the standard deviation of the z-coordinate measured by different individuals is very small, and the mean values of height are very close to 10, 15, and 20 cm. Thus, the hand-measurement errors for the z-coordinate are almost negligible.

To train and identify the model F between (X_{c}, Y_{c}, Z_{c}) and (X_{w}, Y_{w}, Z_{w}), as presented in Section 2, a dataset containing true values of the world coordinates of the marker needs to be attained first for each camera. Within each camera's view, the marker is placed at 50 different locations. Then, its camera coordinate values are determined using Eqs (3), (4), and (5) by processing the collected images, and those in the world coordinate are manually measured following the procedure described above. Thus, 150 data pairs of true values of (X_{w}, Y_{w}, Z_{w}) and (X_{c}, Y_{c}, Z_{c}) are acquired. Out of the 50 pairs of data for each camera, 40 are randomly selected for model training, and the rest 10 are for testing. The 3D and 2D views of all the 150 locations of the ArUco markers in the world coordinate system are shown in FIG. 9(a) and (b), respectively, and each dot represents one marker location. Dots in black and red, respectively, denote the locations for training and testing model F.

### 4. Experimental Results

In this section, models above for F are evaluated using the testing data that is not present in the training process. Two sets of experiments within the 3D and 2D domains are conducted. In the former, the marker is also placed at different heights, while in the latter, the marker is on the floorboard, that is, Z_{w}=0.

### 4.1. 3D Positioning

The model performances are first evaluated for 3D positioning and the accuracy metric is defined as [2, 33]

$$ε = \sqrt{{( {X}_{w , g} - {\hat{X}}_{w} )}^{2} + {( {Y}_{w , g} - {\hat{Y}}_{w} )}^{2} + {( {Z}_{w , g} - {\hat{Z}}_{w} )}^{2}} \qquad ( 26 )$$

where (X_{w,g}, Y_{w,g}, Z_{w,g}) are the ground truth value of the world coordinate of the ArUco marker and are manually measured using Eq. (25) and following the procedure above. (\hat{X}_{w}, Ŷ_{w}, \hat{Z}_{w}) are those estimated by our models and algorithms.

FIG. 9(f) illustrates a chart (Table 4) representing performance of nine different methods in 3D indoor positioning, comparing such models for all three cameras (red, white, and black, as shown in FIGS. 5(a) and (b)) in mean accuracy, lower bound, upper bound, and standard deviation. Differences in performance among the three cameras are caused by the discrepancy in camera installation and intrinsic parameters of cameras. In total, nine different models/methods are listed in FIG. 9(f) (Table 4). Method 1 is the rigid transformation method and is denoted RT hereafter. The mean accuracy of RT for red, white, and black cameras is 1.430, 2.344, and 3.422 cm, respectively. Method 2 is the polynomial regression (PR) method, and its mean accuracy for all three cameras is around 1.5 cm. The lower bound and standard deviation of PR are both lower than 1 cm, and the upper bound is less than 4 cm. Compared to RT, PR shows excellent improvement in lower bound, upper bound, and standard deviation. In Method 3, that is, RT+PR hybrid model, RT is applied to estimate the world coordinates (\tilde{X}_{w}, \tilde{Y}_{w}, \tilde{Z}_{w}) first, and then these intermediate values are used by PR as the input to estimate the world coordinates again to further improve the accuracy. The mean accuracy, lower bound, upper bound, and standard deviation of RT+PR are the same as that of PR.

Method 4, that is, ANN, is the machine learning-based regression model to estimate the world coordinates. The mean accuracy of ANN ranges from 1.5 to 2.0 cm, which is slightly worse than those of PR. The lower bound of ANN is also lower than 1 cm, and its upper bound and standard deviation are slightly higher than those of PR. In Method 5, that is, RT+ANN, the ANN model uses the estimated world coordinates from RT as inputs to estimate the world coordinates again. It seems that this hybrid model does not contribute to significant improvement in the mean accuracy. The accuracy of RT+ANN is between 1.5 and 1.8 cm, and its lower bound is also less than 1 cm. However, its upper bound and standard deviation are slightly inferior to that of ANN only. In Method 6, the Kriging Interpolation (KI) model is used to estimate the world coordinates. Compared to that of PR, the mean accuracy of KI is superior for the red camera but much worse for the white and black cameras. The upper bound and standard deviation of KI are also much higher than that of PR.

Method 7 is the hybrid model combining RT+KI. Its mean accuracy is almost the same as that of KI. The differences in the lower bound, upper bound, and standard deviation between RT+KI and KI are indeed minor. Method 8 uses Kriging regression (KR) to estimate the coordinate value of the marker in the world frame. In contrast to KI, KR achieves better mean positioning accuracy for the black camera. However, the upper bound and standard deviation for the red and black cameras of KR are worse than that of KI. In Method 9, RT+KR forms a hybrid model to further improve the world coordinate estimation using the intermediate results from RT. Basically, there is no notable difference in the mean accuracy between KR and RT+KR. Their lower bound, upper bound, and standard deviation are also almost identical.

Through the comparison of these data-driven modeling methods, several interesting observations can be made. The combination of RT and other methods, such as RT+PR, RT+ANN, RT+KI, and RT+KR, makes a negligible contribution to mean accuracy improvement when compared to the single PR, ANN, KI, and KR. The difference in the mean accuracy among these nine methods is minor for the red camera but is noticeable for white and black cameras. PR and RT+PR are clearly top performers and achieve a mean accuracy of around 1.5 cm for all cameras and greatly outperform the other methods. And the lower bound, upper bound, and standard deviation for PR and RT+PR are the same. Compared to existing research works using the ArUco marker, the present system achieves a value of around 1.5 cm, a significant improvement in 3D indoor positioning accuracy.

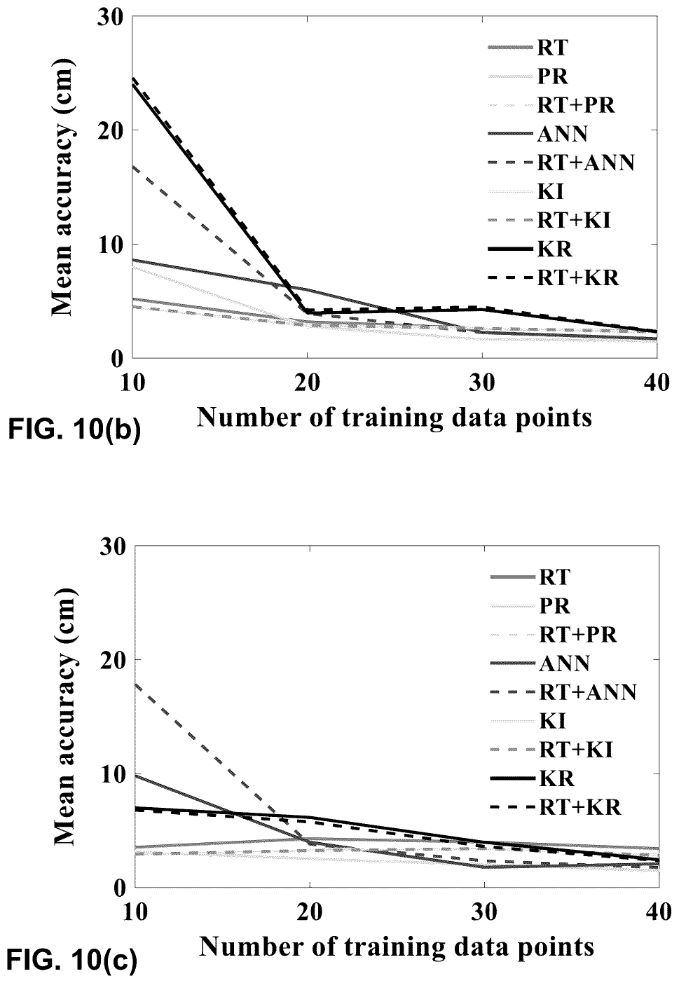

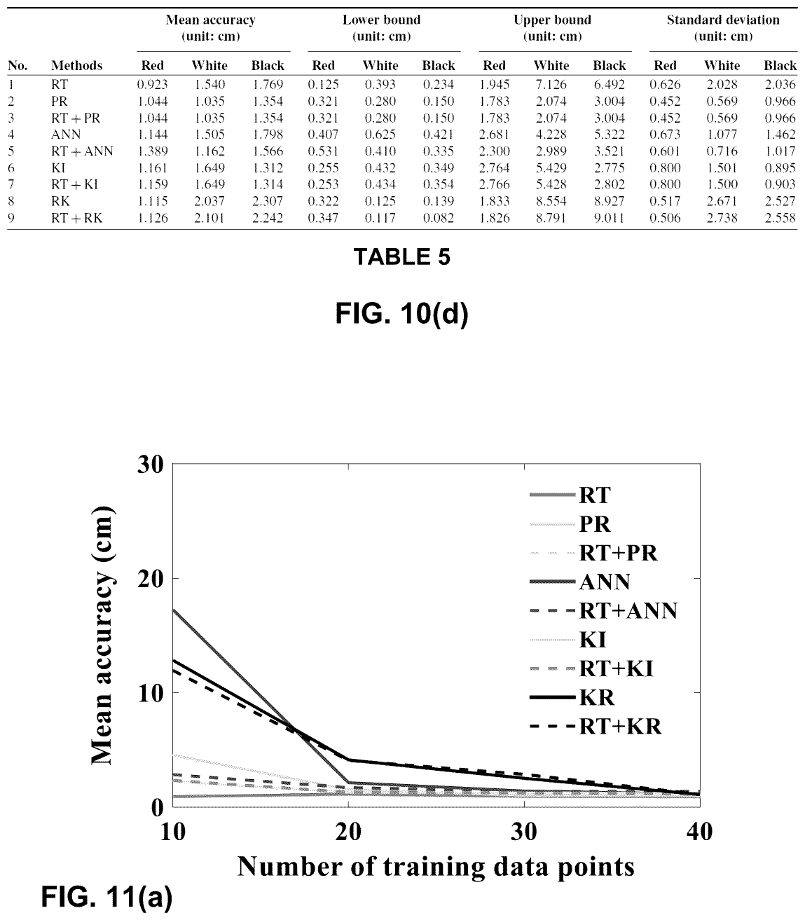

All these nine modeling methods in FIG. 9(f) (Table 4) perform well in positioning when the number of training data is 40 for each camera. However, the manual measurement and data collection are tedious and time-consuming and should be minimized subject to the positioning accuracy requirement. Therefore, the tradeoff between positioning accuracy and the training data size is also studied. FIGS. 10(a), 10(b), and 10(c) respectively illustrate graphically the effect of the number of training data points on 3D positioning accuracy, from the (a) red, (b) white, and (c) black cameras, respectively. Thus, analysis is conducted to investigate the influence of the number of training data points (10, 20, 30, and 40) on positioning accuracy, with FIGS. 10(a), 10(b), and 10(c) showing the mean accuracy for the red, white, and black cameras, respectively. Again, the training data points are selected randomly from the data pool in FIGS. 9(a) and 9(b), and the locations of testing points remain the same. It is interesting to observe that the mean accuracy of these methods, in general, improves as more training data points are incorporated. All of them yield a mean accuracy of less than 10 cm when the number of training data points is 20 or more. In addition, even with the same method, the accuracy of different cameras can be different because the locations of selected training and testing data and the camera installation all affect model performance. The mean accuracy of ANN, RT+ANN, KR, and RT+KR deteriorates appreciably when training data are limited, while that of RT, PR, RT+PR, KI, and RT+KI maintain relatively constant with different amounts of training data. Especially, RT performs very consistently and even exceeds PR when only 10 data points are used, and its mean accuracy for all three cameras mostly keeps below 5 cm, which may be ascribed to physics/kinetics contained in its mathematical form in Eq. (6) that alleviates the demand for data. Our observation implies that when training data is scarce, and it is difficult to collect more, RT and KI may be more appropriate for modeling the mapping relationship F.

### 4.2. 2D Positioning

When the system is used for a mobile robot, and the height of the attached ArUco marker does not change appreciably, the estimation of the Z_{w} coordinate value is not necessary. Thus, the 2D positioning accuracy is more important, and its evaluation metric will be rewritten by removing the term associated with Z_{w} in Eq. (26)

$$ε = \sqrt{{( {X}_{w , g} - {\hat{X}}_{w} )}^{2} + {( {Y}_{w , g} - {\hat{Y}}_{w} )}^{2}} \qquad ( 27 )$$

In FIG. 10(d) (Table 5), the mean accuracy, lower bound, upper bound, and standard deviation for the nine methods in the 2D domain are listed. The mean accuracy of RT varies between 0.9 and 1.8 cm. The lower bound of RT is relatively small and only 0.4 cm. However, the upper bound is large and reaches 7.126 cm. Besides, its standard deviation is also larger than most methods, as shown in FIG. 10(d) (Table 5). Among all methods, PR and RT+PR again perform the best and achieve the 2D mean accuracy of about 1 cm, and their lower bound, upper bound, and standard deviation are also smaller than those of the other methods. The mean accuracy of ANN, RT+ANN, KI, and RT+KI ranges from 1.1 to 1.8 cm, which is somewhat worse than that of PR and RT+PR. Correspondingly, their lower bound, upper bound, and standard deviation are slightly worse relative to PR and RT+PR. The mean accuracy of KR and RT+KR is the worst compared to other methods, and the discrepancy between the estimation and ground truth can reach 2.307 cm. Although their lower bound is lower, the upper bound and the standard deviation are high and, respectively, over 8 and 2.5 cm. Again, PR and RT+PR exhibit excellent positioning performance, and the combination of RT and PR does not offer apparent advantages over the PR only.

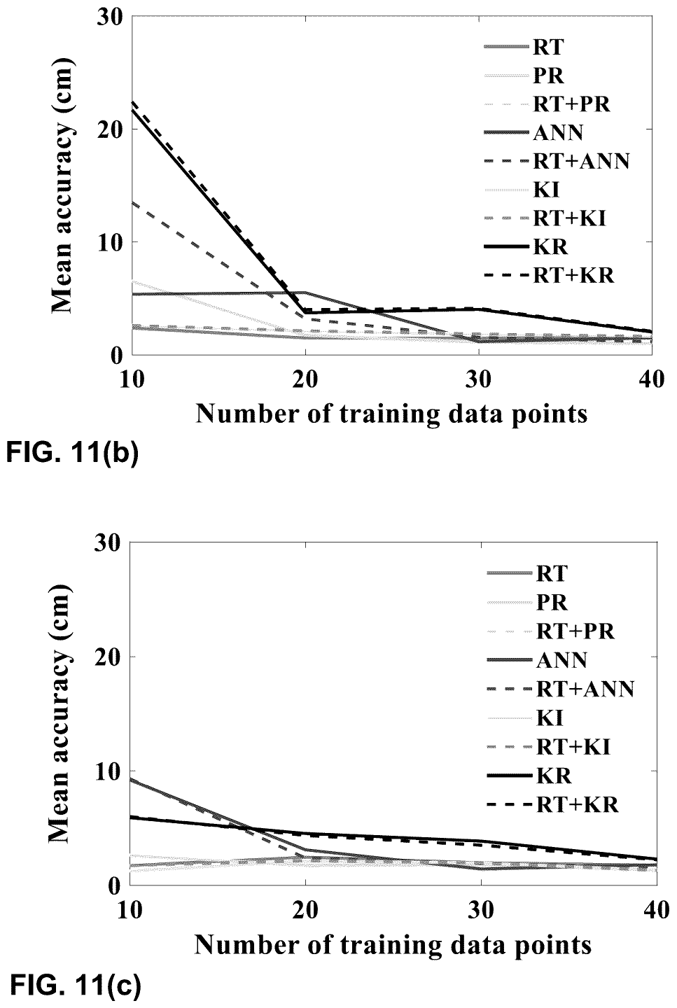

FIGS. 11(a), 11(b), and 11(c) respectively illustrate graphically the effect of the number of training data points on 2D positioning accuracy, from the (a) red, (b) white, and (c) black cameras, respectively, and the general trend and dependence on the training data size is similar to that of 3D positioning. The methods of ANN, RT+ANN, RK, and RT+RK perform poorly when the number of training data points is only 10. All these methods perform very well with a mean accuracy smaller than 10 cm when 20 or more data points are used for model training. RT, RT+PR, PR, KI, and RT+KI are able to keep relatively consistent positioning performance even with only ten training data points, while RT is particularly appealing. Similarly, when only a limited amount of data is available for model training, RT, KI, or RT+KI are preferred.

### 4.3. Verification With Mobile Robot Experiment

Next, a test is carried out to verify that the indoor positioning system can be used to track moving robots in real time for research uses. The indoor positioning system disclosed in this present disclosure is implemented on a laptop with an Intel (R) Core™ i5-7200U CPU@2.50 GHz. The mobile robot moves at a maximum speed of 0.26 m/s. The system processes three frames simultaneously from the three cameras within approximately 0.05 s, which allows real-time positioning and control of the robot. The ArUco marker is placed on the top of a mobile robot, and the centers of both are aligned.

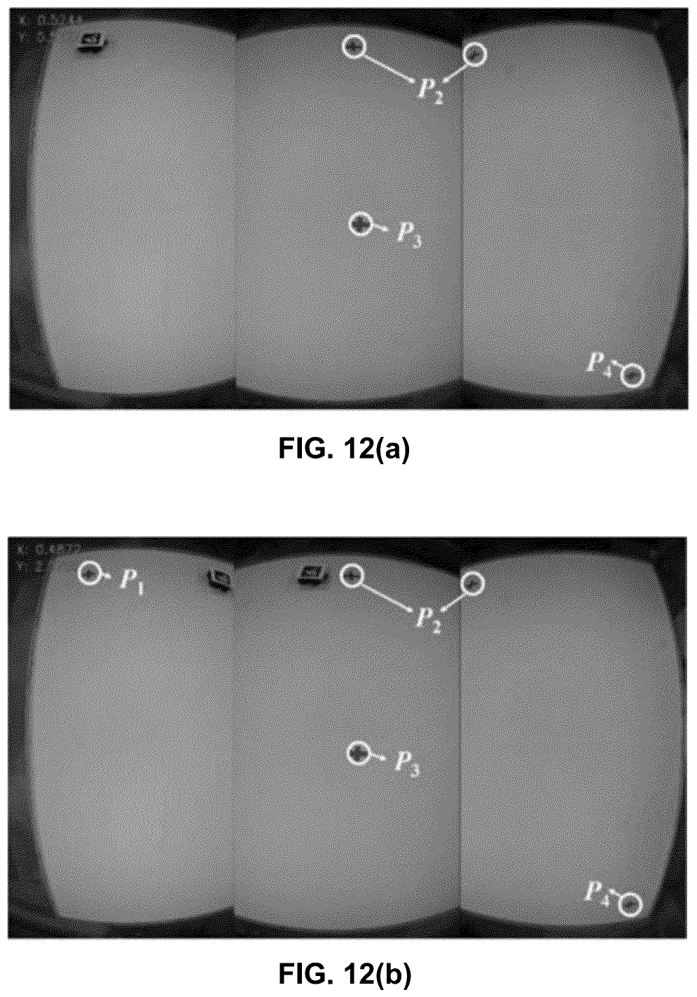

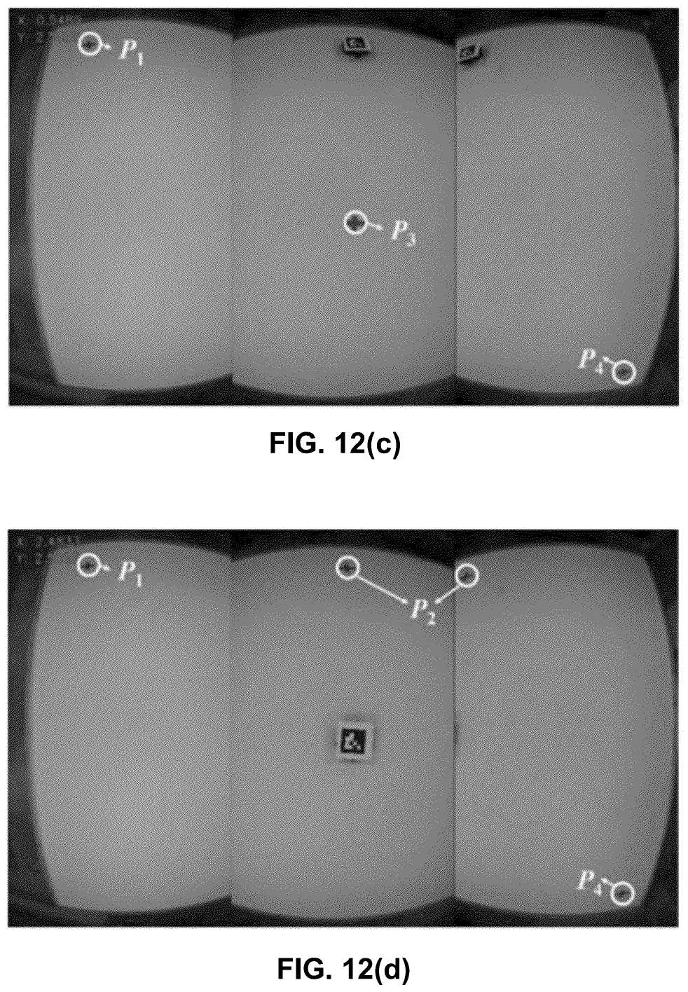

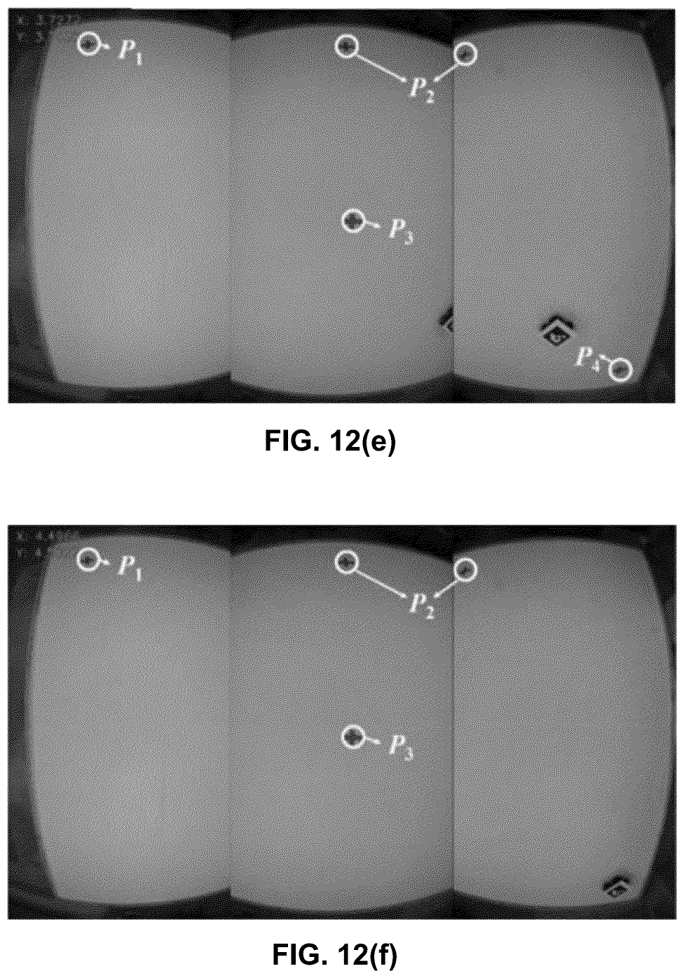

FIGS. 12(a) through 12(f) respectively illustrate images from an exemplary experiment to verify the feasibility of using the presently disclosed indoor positioning system for robot control and research uses. As shown in FIGS. 12(a) through 12(f), respectively, “+” labels are placed at four different locations, which are, respectively, P₁(0.5, 0.5), P₂(0.5, 2.5), P₃(2.5, 2.5), and P₄(4.5, 4.5), all with a unit of meter. They are set as the waypoints for the mobile robot, and the starting position of the robot is around P₁(0.5, 0.5), as shown in FIG. 12(a). In addition, the estimated location of the marker's center in the world coordinate frame, that is, \hat{X}_{w0} and Ŷ_{w0} is shown at the top-left corner of each figure in FIGS. 12(a) through 12(f), respectively. Then the onboard PID controller uses the position information of \hat{X}_{w0} and Ŷ_{w0} to command the robot to go through the four waypoints above sequentially. In FIG. 12(b), it is clearly seen that the mobile robot moves from P₁(0.5, 0.5) to P₂(0.5, 2.5). In FIGS. 12(c) and 12(d), the robot reaches P₂(0.5, 2.5) and P₃(2.5, 2.5) in tandem. Subsequently, the robot is on its way toward P₄(4.5, 4.5), as shown in FIG. 12(e). Finally, the robot arrives at destination P₄(4.5, 4.5) in FIG. 12(f). It should be noted that because of the partially overlapped view between two adjacent cameras, P₂ is present in both the white (middle) and black (right) cameras, and sometimes the robot appears simultaneously in two camera images (e.g., FIGS. 12(b), 12(c), and 12(e)). This experiment verifies that the present indoor positioning system can track the mobile ground robot and provides accurate position information in real time for robot control.

### 5. Conclusion

In this disclosure, a low-cost and accurate positioning system, along with a novel pipeline to combine image processing and data-driven modeling, is disclosed for robotics research and education. Both hardware and algorithms, in conjunction with software-hardware interfacing, are disclosed for automated image acquisition and processing, computing, and positioning, all in real time. The key contribution of the present effort is to push the limit of positioning accuracy through optimally selected algorithms while minimizing the overall cost of hardware and installation, which makes it more affordable to the broad robotics community.

Our system includes multiple overhead cameras to acquire images of the ArUco marker. OpenCV is employed to extract its normalized image coordinates. A new numerical procedure is formulated to convert them to the camera coordinate frame. The mapping of the marker's position from the camera coordinate to the world coordinate is tackled by data-driven models. Various modeling techniques are interrogated, including rigid transformation, polynomial regression, artificial neural network, Kriging interpolation and regression, and hybrid models. A dataset is also constructed, which contains manually measured data pairs at 150 locations. The trained model enables real-time estimation of the world coordinate values of the ArUco marker (and its robot carrier).

Experimental studies are also carried out for both 3D and 2D positioning. Polynomial regression, although straightforward to implement, exceeds most other methods and yields a positioning accuracy of about 1.5 cm. Rigid transformation and Kriging interpolation preserve consistent performance even if only ten train data points are used, yielding a mean accuracy mostly within 5 cm. Another test of the mobile robot is also performed, which uses the real-time position information provided by our system for navigation and control. The present system is shared as an open-source tool in the public domain, and it is anticipated to contribute to robotics studies and education in resource-limited environments, particularly those in geographically underdeveloped regions.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms “a” or “an” entity or object refers to one or more of such entity or object. Accordingly, the terms “a”, “an”, “one or more,” and “at least one” can be used interchangeably herein.

### REFERENCES

[1] A. R. Jiménez and F. Seco, “Comparing Decawave and Bespoon UWB Location Systems: Indoor/Outdoor Performance Analysis,” 2016 International Conference on Indoor Positioning and Indoor Navigation (IPIN), 2016 Oct. 4 (IEEE, 2016) pp. 1-8.
[2] R. Amsters, E. Demeester, N. Stevens, Q. Lauwers and P. Slaets, “Evaluation of Low-Cost/High-Accuracy Indoor Positioning Systems,” Proceedings of the 2019 International Conference on Advances in Sensors, Actuators, Metering and Sensing (ALLSENSORS), Athens, Greece 2019 Feb. 24 (2019) pp. 24-28.
[3] J. Kuang, X. Niu, P. Zhang and X. Chen, “Indoor positioning based on pedestrian dead reckoning andmagnetic field matching for smartphones,” Sensors 18(12), 4142 (2018).
[4] H. Ju, S. Y. Park and C. G. Park, “A smartphone-based pedestrian dead reckoning system with multiple virtual tracking for indoor navigation,” IEEE Sens. J. 18(16), 6756-6764 (2018).
[5] R. Ali, R. Liu, A. Nayyar, B. Qureshi and Z. Cao, “Tightly coupling fusion of UWB ranging and IMU pedestrian dead reckoning for indoor localization,” IEEE Access 9, 164206-164222 (2021).
[6] M. Mareedu, S. Kothacheruvu and S. Raghunath, “Indoor Navigation Using Ultra-Wideband Indoor Positioning System (IPS),” AIP Conference Proceedings, 2021 Dec. 1, AIP Publishing LLC, vol. 2407 (2021) pp. 020022.
[7] Z. Zhang, M. Lee and S. Choi, “Deep-learning-based wi-fi indoor positioning system using continuous CSI of trajectories,” Sensors 21(17), 5776 (2021).
[8] P. Bencak, D. Hercog and T. Lerher, “Indoor positioning system based on bluetooth low energy technology and a nature inspired optimization algorithm,” Electronics 11(3), 308 (2022).
[9] T. Zhou, J. Ku, B. Lian and Y. Zhang, “Indoor positioning algorithm based on improved convolutional neural network,” Neural Comput. Appl. 34(9), 6787-6798 (2022).
[10] S. Yan, Y. Su, A. Sun, Y. Ji, J. Xiao and X. Chen, “Low-Cost and Lightweight Indoor Positioning Based on Computer Vision,” 2022 4th Asia Pacific Information Technology Conference 2022 Jan. 14 (2022) pp. 169-175.
[11] Z. Y. Ng, Indoor-Positioning for Warehouse Mobile Robots Using Computer Vision (Doctoral dissertation, UTAR).
[12] J. Kunhoth, A. Karkar, S. Al-Maadeed and A. Al-Ali, “Indoor positioning and wayfinding systems: A survey,” Hum.-Centric Comput. Infor. Sci. 10(1), 1-41 (2020).
[13] J. Kuang, X. Niu and X. Chen, “Robust pedestrian dead reckoning based on MEMS-IMU for smartphones,” Sensors 18(5), 1391 (2018).
[14] B. Wang, X. Liu, B. Yu, R. Jia and X. Gan, “Pedestrian dead reckoning based on motion mode recognition using a smartphone,” Sensors 18(6), 1811 (2018).
[15] X. Liu, Z. Jiao, L. Chen, Y. Pan, X. Lu and Y. Ruan, “An enhanced pedestrian dead reckoning aided with DTMB signals,” IEEE Trans. Broadcast 68(2), 407-413 (2022).
[16] A. R. Ruiz and F. S. Granja, “Comparing ubisense, bespoon, and decawave uwb location systems: Indoor performance analysis,” IEEE Trans. Inst. Meas. 66(8), 2106-2117 (2017).
[17 ] P. Sthapit, H. S. Gang and J. Y. Pyun, “Bluetooth Based Indoor Positioning Using Machine Learning Algorithms,” 2018 IEEE International Conference on Consumer Electronics-Asia (ICCE-Asia), 2018 Jun. 24 (IEEE, 2018) pp. 206-212.
[18] Z. Han, Z. Wang, H. Huang, L. Zhao and C. Su, “WiFi-based indoor positioning and communication: Empirical model and theoretical analysis,” Wireless Commun. Mobile Comput., 2022 1-12 (2022).
[19] S. Jia, L. Ma, S. Yang and D. Qin, “A novel visual indoor positioning method with efficient image deblurring,” IEEE Trans. Mobile Comput., 1-1 (2022).
[20] X. Liu, H. Huang and B. Hu, “Indoor visual positioning method based on image features,” Sens. Mater. 34(1), 337-348 (2022).
[21] Y. Li, Z. Ghassemlooy, X. Tang, B. Lin and Y. Zhang, “A VLC smartphone camera based indoor positioning system,” IEEE Photonic Tech. Lett. 30(13), 1171-1174 (2018).
[22] M. Kalaitzakis, B. Cain, S. Carroll, A. Ambrosi, C. Whitehead and N. Vitzilaios, “Fiducial markers for pose estimation,” J. Intell. Rob. Syst. 101(4), 1-26 (2021).
[23] G. C. La Delfa, S. Monteleone, V. Catania, J. F. De Paz and J. Bajo, “Performance analysis of visualmarkers for indoor navigation systems,” Front. Inform. Technol. Electron. Eng. 17(8), 730-740 (2016).
[24] K. S. Arun, T. S. Huang and S. D. Blostein, “Least-squares fitting of two 3-D point sets,” IEEE Trans. Pattern Anal. September(5), 698-700 (1987).
[25] A. Kurobe, Y. Sekikawa, K. Ishikawa and S. H. Corsnet, “3d point cloud registration by deep neural network,” IEEE Robot. Autom. Lett. 5(3), 3960-3966 (2020).
[26] A. Sobester, A. Forrester and A. Keane, Engineering Design Via Surrogate Modelling: A Practical Guide (John Wiley & Sons, 2008).
[27] N. Kato, B. Mao, F. Tang, Y. Kawamoto and J. Liu, “Ten challenges in advancing machine learning technologies toward 6G,” IEEE Wireless Commun. 27(3), 96-103 (2020).
[28] H. Yang, S. H. Hong, G. Wang and Y. Wang, “Multi-fidelity reduced-order model for GPU-enabled microfluidic concentration gradient design,” Eng. Comput. 1-19 (2022).
[29] C. R. Dietrich and M. R. Osborne, “Estimation of covariance parameters in kriging via restricted maximum likelihood,” Math. Geol. 23(1), 119-135 (1991).
[30] S. N. Lophaven, H. B. Nielsen and J. Søndergaard. DACE: A Matlab Kriging Toolbox (IMM, Informatics and Mathematical Modelling, The Technical University of Denmark, Lyngby, Denmark, 2002).
[31] I. Couckuyt, T. Dhaene and P. Demeester, “ooDACE toolbox: A flexible object-oriented Kriging implementation,” J. Mach. Learn. Res. 15, 3183-3186 (2014).
[32] T. Kyzer, Instrumentation and Experimentation Development for Robotic Systems (Doctoral dissertation, University of South Carolina).
[33] S. H. Hong, J. Ou and Y. Wang, “Physics-guided neural network and GPU-accelerated nonlinear model predictive control for quadcopter,” Neural Comput. Appl. 13(1), 1-21 (2022).

What is claimed is:

1. Method for determining the position of a movable target in an established area, comprising:
tagging the movable target with a fiducial marker having a distinctive pattern;
providing at least one camera positioned for outputting image coverage of the established area in which the target can move;
producing camera coordinates of the fiducial marker; and
inputting the camera coordinates of the fiducial marker into a trained model for estimating mapping of the world coordinates of the fiducial marker from the camera coordinates,
whereby determining the world coordinates of the fiducial marker determines in the established area the position of the movable target tagged with the fiducial marker.

2. The method according to claim 1, wherein producing camera coordinates of the fiducial marker includes:
providing a plurality of cameras respectively positioned for outputting collective image coverage of the established area in which the target can move
producing normalized image coordinates of the fiducial marker from the collective image coverage; and
producing camera coordinates of the fiducial marker.

3. The method according to claim 2, wherein:
the plurality of cameras comprise at least three cameras; and
the fiducial marker comprises one of a ARTag, AprilTag, ArUco, or STag marker.

4. The method according to claim 3, wherein:
the fiducial marker comprises an ArUco marker; and
the movable target comprises a mobile robot.

5. The method according to claim 2, wherein:
the established area comprises an indoor floorboard;
the plurality of cameras are aligned generally parallel to the floorboard; and
the plurality of cameras each have a relatively low level of resolution.

6. The method according to claim 2, wherein the trained model comprises a data-driven model trained using at least one of rigid transformation, polynomial regression, machine learning, Kriging interpolation, Kriging regression, and hybrid models to establish a mapping relationship between the camera coordinates as input and the world coordinates as output.

7. The method according to claim 6, wherein the trained model comprises a hybrid model by which a rigid transformation model is first used to obtain intermediate values of the world coordinates, which are then entered as the input to one of polynomial regression, machine learning, Kriging interpolation, and Kriging regression data-driven models to output final values of the world coordinates.

8. The method according to claim 6, wherein the trained model comprises a polynomial regression data-driven model.

9. The method according claim 6, wherein the data-driven model is trained on ground truth data comprising measured locations of at least one of a fiducial marker or of at least one reference point in the established area.

10. The method according to claim 9, wherein the ground truth data points are relatively limited in number, and the data-driven model is trained using at least one of rigid transformation and Kriging interpolation models.

11. The method according to 3, wherein border regions between two adjacent cameras have partial overlap comprising an overlap area which is larger than the marker, so that camera coordinates of the marker can be obtained at any location of the established area.

12. A system for determining the position of a movable target in an established area, comprising:
a movable target tagged with a fiducial marker having a distinctive pattern;
at least one camera positioned for outputting image coverage of the established area in which the target can move; and
one or more processors programmed for:
producing camera coordinates of the fiducial marker; and
inputting the camera coordinates of the fiducial marker into a trained model for estimating mapping of the world coordinates of the fiducial marker from the camera coordinates,
whereby determining the world coordinates of the fiducial marker determines in the established area the position of the movable target tagged with the fiducial marker.

13. The system according to claim 12, further comprising:
a plurality of cameras respectively positioned for outputting collective image coverage of the established area in which the target can move; and
wherein producing camera coordinates of the fiducial marker includes producing normalized image coordinates of the fiducial marker from the collective image coverage; and
producing camera coordinates of the fiducial marker.

14. The system according to claim 13, wherein:
the plurality of cameras comprise at least three cameras; and
the fiducial marker comprises one of a ARTag, AprilTag, ArUco, or STag marker.

15. The system according to claim 14, wherein:
the fiducial marker comprises an ArUco marker; and
the movable target comprises a mobile robot.

16. The system according to claim 13, wherein:
the established area comprises an indoor floorboard;
the plurality of cameras are aligned generally parallel to the floorboard; and
the plurality of cameras each have a relatively low level of resolution.

17. The system according to claim 13, wherein the one or more processors are further programmed so that the trained model comprises a data-driven model trained using at least one of rigid transformation, polynomial regression, machine learning, Kriging interpolation, Kriging regression, and hybrid models to establish a mapping relationship between the camera coordinates as input and the world coordinates as output.

18. The system according to claim 17, wherein the one or more processors are further programmed so that the trained model comprises a hybrid model by which a rigid transformation model is first used to obtain intermediate values of the world coordinates, which are then entered as the input to one of polynomial regression, machine learning, Kriging interpolation, and Kriging regression data-driven models to output final values of the world coordinates.

19. The system according to claim 17, wherein the one or more processors are further programmed so that the trained model comprises a polynomial regression data-driven model.

20. The system according to claim 17, wherein the one or more processors are further programmed so that the trained model comprises a data-driven model trained using at least one of rigid transformation and Kriging interpolation models.

21. The system according to 14, wherein the plurality of cameras are configured so that border regions between two adjacent cameras have partial overlap comprising an overlap area which is larger than the marker, so that camera coordinates of the marker can be obtained at any location of the established area.
